(19) United States
(12) Patent Application Publication
(10) Pub. No.: US 2009/0033747 A1
(43) Pub. Date: Feb. 5, 2009

(54) Method and System for Monitoring Quality of Live Video Feed From Multiple Cameras

(75) Inventor: Darin Edward Chambers, Leesburg, VA (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Trafficland Inc., Fairfax, VA (US)

(21) Appl. No.: 11/831,300

(22) Filed: Jul. 31, 2007

(51) Int. Cl. H04N 17/00

(52) U.S. Cl. 348/187; 348/E17.002

(57) ABSTRACT

A method and system for monitoring the quality of video cameras automatically performs one or more tests on a current image received from each of the cameras. The cameras are connected to a network, such as the Internet, and are generally of different types and are owned and/or operated by various entities. A current image from each of the cameras is evaluated using image processing techniques so that a human need not have to view the camera imagery when an initial evaluation is made. Evaluation parameters may include such things as whether a camera is outputting a predefined error image, an image whose brightness is bad, or an image with bad hues. The status of each camera on a network is stored along with a snapshot of the image from which an evaluation was made and a time stamp. The data are made available to the operator of the camera for maintenance and other purposes.

### FIELD OF THE INVENTION

The present invention is directed to a method and system for monitoring the quality of live video captured by multiple cameras. More particularly, it concerns how such information can be gathered over a network, such as the Internet, and then disseminated to cognizant individuals for further processing and troubleshooting.

### BACKGROUND OF THE INVENTION

Remote video cameras connected to a network need to be monitored to make sure that they are operating as intended. A network, such as the Internet, may have numerous cameras, of different brands and types, and the cameras may be owned and/or operated by various entities (collectively referred to here as ‘operators’) such as corporations, government organizations, schools, and the like. Imagery from any given camera may be made available to everyone, or only to those individuals authorized to receive the imagery, depending on the policies of the operator.

Monitoring whether a given camera is operating properly is a concern to the various operators. One solution is to have a person look at the imagery received from each camera on a periodic basis. However, this can be expensive when there are large numbers of cameras, or if each camera's video output must be examined with frequent regularity.

### SUMMARY OF THE INVENTION

In one aspect, the present invention is directed to a method for automatically determining whether each of a plurality of video cameras is operating properly. The cameras, which generally include cameras of different types, are placed in different geographical locations and are operated by different entities. The determination is made based on imagery provided by each such video camera. The method comprises, for each of said plurality of video cameras: obtaining a current image from a selected video camera over the Internet, each current image comprising a two-dimensional array of pixels having an integer number N bits; histogramming pixels of the current image to form a current image signature using only a reduced integer number M bits to represent pixel values within the current image, M<N; and comparing the current image signature with at least one reference color frequency signature appropriate for a camera type of said selected video camera, to determine whether said selected video camera is outputting a pre-defined error image.

In another aspect, the present invention is directed to a system which can implement the above-stated method.

### BRIEF DESCRIPTION OF THE DRAWINGS

For a better understanding of the present invention and to show how the same may be carried out in practice, reference will now be made to the accompanying drawings, in which:

FIG. 1 depicts an overall environment to which one embodiment of the present invention may apply;

FIG. 2 depicts the steps that an image undergoes when its quality is evaluated, in accordance with one embodiment of the present invention;

FIG. 3 depicts the process for creating a color frequency signature for a given image, in accordance with one embodiment of the present invention;

FIG. 4 depicts the process for comparing a newly calculated color frequency signature to see if it matches a reference color frequency signature;

FIGS. 5A and 5B depict an exemplary reference color frequency signature and a sample current color frequency signature, in accordance with one embodiment of the present invention;

FIG. 6 presents a table of Status ID's and their meanings;

FIG. 7 presents a web page from which an operator may access information about the quality of imagery from the cameras connected to a network;

FIG. 8 presents summary statistics of the image quality of all cameras;

FIG. 9 presents an example of one camera's image quality history; and

FIG. 10 presents an example of imagery and other information from the cameras belonging to one camera operator.

### DETAILED DESCRIPTION OF THE INVENTION

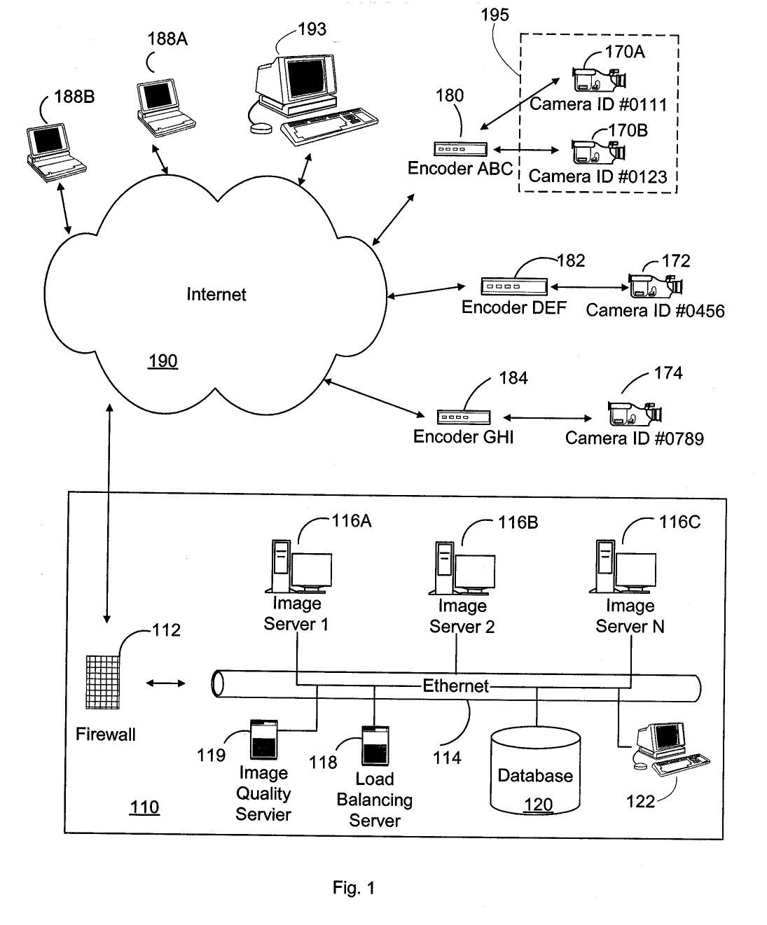

FIG. 1 shows the overall environment in which the present invention may be used. A system 110 represents the installation of an operator of a web site.

In this particular embodiment, the web site provides a user, depicted by either computer 188A, 188B, with imagery from any one of a plurality of video cameras, shown generally as 170A, 170B, 172, 174. As seen in FIG. 1, cameras 170A, 170B are both connected to one encoder 180 (on separate channels); camera 172 is connected to a second encoder 182 and camera 174 is connected to third encoder 184. In one embodiment, each encoder 180, 182, 184 has a plurality of channels and a camera is connected to a specific channel of an associated encoder. And, as is known to those skilled in the art, an encoder grabs a frame from the camera and outputs the frame in digital form, at some specified resolution and size.

In general, each video camera views a different scene. In one embodiment, each camera shows a traffic scene, e.g., a portion of road so that users of the web site can see the traffic conditions on that road. Thus, the different cameras may show different portions of the same road, or they may show portions of entirely different roads, located in entirely different states, or even countries. Also, while only four cameras are shown in FIG. 1, it is understood that thousands of such cameras, distributed in many different areas of interest, may be present, each connected to an encoder. Each of the encoders 180, 182, 184 has a unique Internet Protocol (IP) address and is connected to the Internet, shown generally as a cloud 190. An example of such a traffic-oriented web site is www.trafficland.com. As a result, all users 188A, 188B may selectively view the traffic scene seen by any one of the cameras 170A, 170B, 172, 174.

The encoders 180, 182, 184 and cameras may belong to someone other than the operator of the system 110. Thus, some cameras and encoders may belong to a private entity, while others may belong to a local government. This way, the entity to whom the cameras and encoders belong may contract with the operator of the system 110 to provide web-based access to imagery from scenes seems by a given camera. For present purposes, it is assumed that the cluster 195 of cameras 170A, 170B are owned by a common entity, such a department of transportation, which contracts with the web site. In one embodiment of the present invention, this entity is able to monitor the performance of its cameras 170A, 170B via a browser running on a computer 193.

The operator's system 110 includes a number of hardware and software assets. The system 110 may include a firewall 112 to permit the remaining assets to safely communicate across the Internet 190. Behind the firewall 112 is a local area network 114, preferably implemented with Ethernet, though other network standards may be used instead. Connected to the network 114 are a plurality of image servers 116A, 116B, 116C. While only three such image servers are shown, it is understood that other numbers of image servers may be used instead. Also connected to the network 114 is an image quality server 119, a load balancing server 118, database 120 and at least one monitoring computer 122. It is understood that additional assets may also be connected to the local area network, such as additional web servers, output devices and the like. It is also understood that any of these assets may communicate with each other.

A user 188A, 188B visits the operator's web site via a browser and requests imagery from a specific camera. An http-type user request is formulated at the user's computer and is submitted to the system 110. This incoming request includes such information as the user's IP address, and camera information, such as the camera number and the resolution of the image to be provided to the user. The incoming request is sent to the load balancing server 118. The load balancing server 118 checks the instantaneous workloads of the imager servers 116A, 116B, 116C and assigns the request to one of the servers.

The user's request to view the scene at a specific camera (and also possibly at a specific size and/or resolution) is received at the load balancing server 118. The user request is generally an http request with routing information so that a response may be sent back to the requesting user, camera identifying information, resolution and/or size of image requested, and perhaps other data as well. The load balancing server 118 assigns the new request to one of the image servers 116A, 116B, 116C. The decision as to which of the plurality of servers the new request is to be assigned can be done in a number of ways. In one paradigm, the new request is given to the image server that has the fewest current image processes, i.e., is handling the fewest current requests. In another paradigm, the load balancing server 118 gives the new request to the image server whose previous request was received the longest time ago. In yet another paradigm, the load balancing server 118 determines an instantaneous load based on the dwell time of the requests and other factors to determine which of the image servers is the least taxed.

It is also possible for a single image engine application to support multiple threads, a single image server having a single image cache and a single request cache may be used. In such case, there is no need for a load balancing server, since only one image server is used, and this single image server handles all user requests. It is even possible that the single image server also serves as the image quality server.

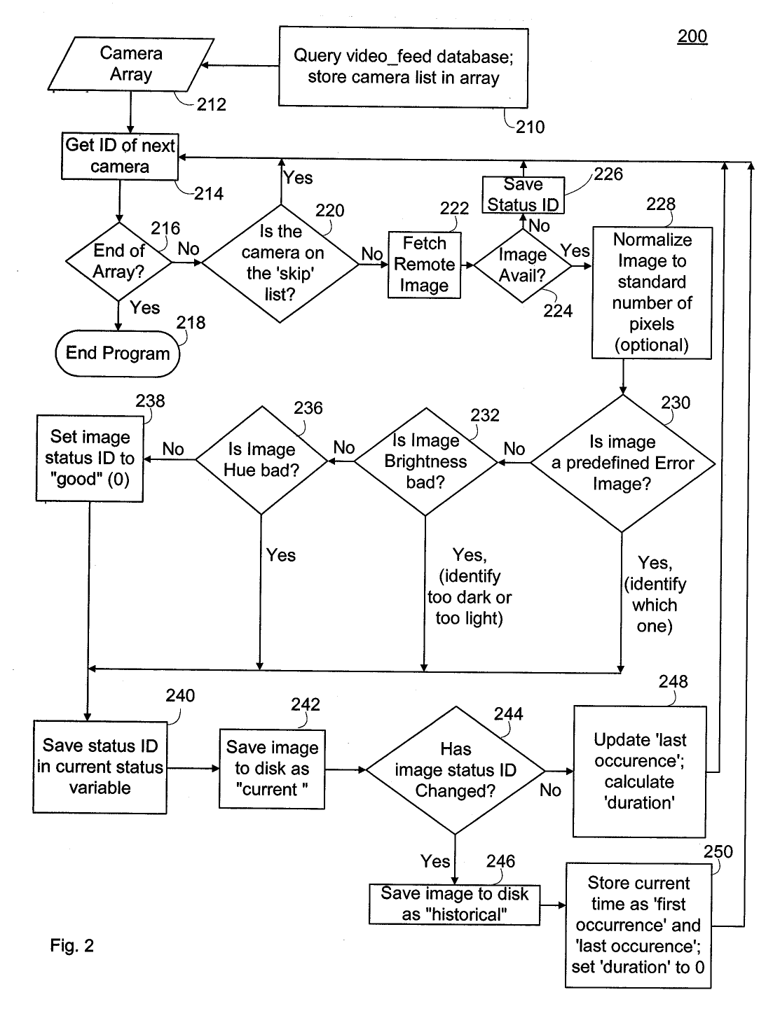

FIG. 2 illustrates a flow chart 200 depicting the principal steps carried out to evaluate and classify the image quality of the video images from each of a plurality of cameras monitored by the web site 110. It is understood that in one embodiment, the steps in the flow chart 200 of FIG. 2 are performed by the image quality server 119, appropriately programmed, with possible use/assistance of the database 120.

In one embodiment, the steps in flow chart 200 are repeated periodically. However, there is no requirement that images from all the cameras are evaluated and classified in a single ‘run’. For example, images from only one-half of all cameras may be evaluated at some time T1 while images from a second half of the cameras are evaluated at some later time T2, after which this alternating cycle is repeated. Similarly, various subsets of cameras, such as only those cameras belonging a particularly entity, may be evaluated at certain times.

The image quality server 119, and/or the database 120, keeps a record for each camera connected to the web site 110. The record for each camera includes a number of fields, including: (1) a camera ID field; (2) a “status” code field; a ‘first occurrence of present state’ field; (3) a ‘last occurrence of present state’ field; and (4) a ‘duration of present state’ field. It is understood that each camera record may include additional fields to keep track of such things as ‘location’, ‘owner’, ‘associated encoder ID’, camera codes, and so forth

In step 210, identifying information about the cameras whose video quality is to be evaluated on a particular run is retrieved from a database to prepare a list 212 of cameras. In step 214, the camera ID of the next camera is fetched from the list. For purposes of describing FIG. 2, we will call the current camera, camera #ABCD.

If, at step 216, the pointer was at the end of the list of cameras to be evaluated on this particular run, control flows to step 218 and the run is ended. If the pointer is not at the end of the list, then a check is made at step 220 to determine whether the camera #ABCD is to be skipped (and no image quality evaluation is to be made for that camera). A camera may be skipped if, for example, it is known that the camera had previously been disconnected and so no evaluation is possible. If camera #ABCD is to be skipped, then control returns to step 214 to check for the camera ID# of the next camera.

If, at step 220, it is determined that camera #ABCD is not to be skipped, then at step 222 a new image frame is grabbed from camera #ABCD. In one embodiment, the retrieved image is obtained by the image quality server 119. Alternatively, it may be obtained by one of the image servers 116A, 116B, 116C. At step 224, a check is made to determine whether the image is available. An image may not be available for any of a number of reasons, such as no signal from an encoder or other faulty equipment. If at step 224 it is determined that no image is available, a corresponding status ID is saved for that camera.

If, at step 224, it is determined that an image is available, at step 228 the size of the received image may be normalized to a standard number of pixels. This can be done by techniques such as interpolation, subsampling or other methods, so that all processed images have the same pixel count.

Next, at step 230, a check is made to see if the received image from camera #ABCD corresponds to a pre-defined error image. A pre-defined error image is a pattern sent by a camera where there is no true image signal. One example of a pre-defined error image is an image having a single color, e.g., a “blue screen”. Another example may be an image comprising of horizontal (or vertical) bars comprising a handful of different colors, say, less than 10 or 20. Each camera type may have associated therewith one or more such pre-defined error images, and in step 230, a check is automatically made to see if the received image matches one of these. If there is such a match, control goes to step 240 and a corresponding status ID is stored in a record for that camera, along with a date and time, as further discussed below.

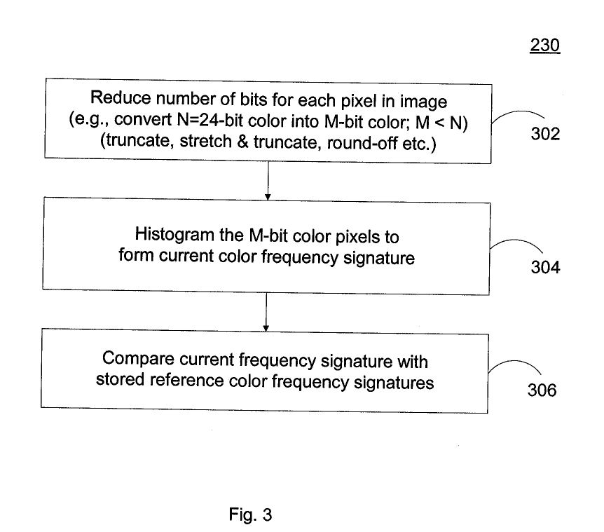

FIG. 3 shows one embodiment of how the check of step 230 may be accomplished. The current image received from the camera comprises N-bit pixels, which means that each pixel may have one of 2^{N} colors. In contrast, though, a pre-defined error image may only have, at most, a few different colors, e.g., 10 or 20. To help reduce the number of colors for which checks must be made, in step 302, the original N-bit pixels are converted into M bits pixels, M<N. In one embodiment, where N=24 bits (and 2^{N} is on the order of 16 million) of which 8 bits each are dedicated to the colors red, blue and green, M may be only 9 or 12 bits such that each color only has 3 or 4 bits. Where M=12, only a total of 2^{M}=2048 different colors remain.

By reducing the total number of bits per color in the current image, the colors are effectively “quantized”. A number of techniques may be used to reduce the number of bits. One way is to simply truncate the K least significant bits of each of the three colors, K being a positive integer less than 8. Another way is to first determine the dynamic range of each color, stretch each color so that it takes up the full 8-bit dynamic range, and only then truncate the K least significant bits of each color. Other ways to quantize color are known to those skilled in the art.

In step 304, the M-bit color pixels are histogrammed into 2^{M} bins to form a current color frequency signature, each bin containing the pixel count of the number of pixels having that color.

In step 306, the current color frequency signature is compared with previously stored reference color frequency signatures to see if there is a match.

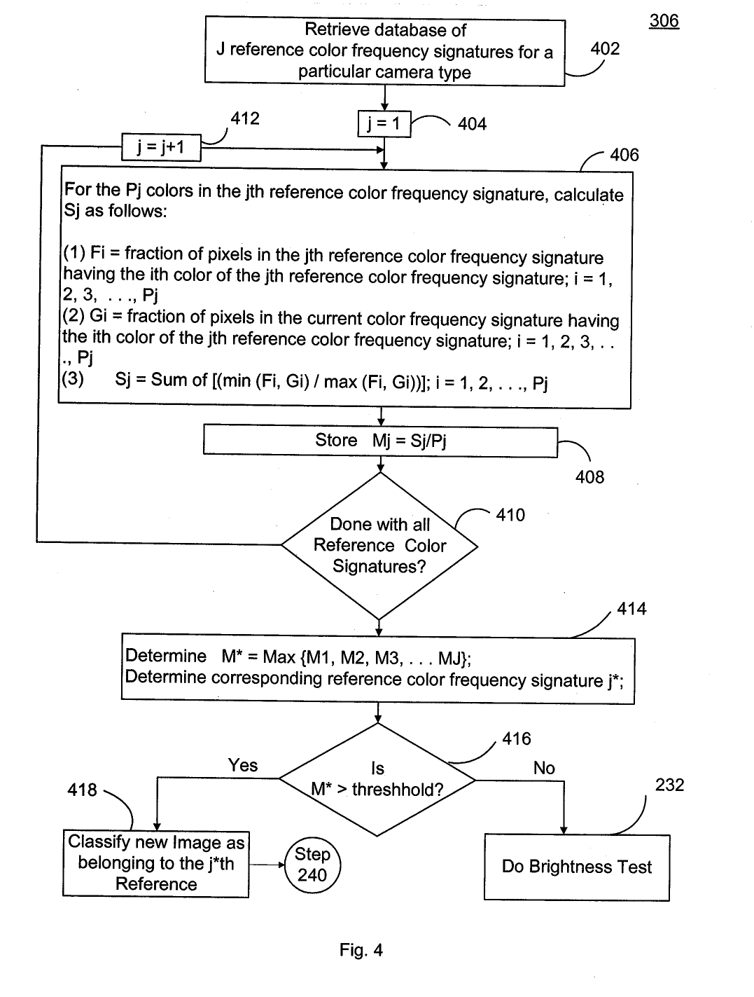

FIG. 4 shows one embodiment of how step 306, in which the current color frequency signature is compared with previously stored reference color frequency signatures, is accomplished. It is again understood that in one embodiment, step 306 is performed by the image quality server 119, appropriately programmed, with possible use/assistance of the database 120.

The camera (in this instance camera #ABCD) may have an integer number J possible reference color frequency signatures, each corresponding to a pre-defined error image as specified by the camera manufacturer. In step 402, the J such reference color frequency signatures are retrieved, and in step 404, a counter j is set to 1. Each reference color frequency signature has a total of Pj different colors, j indexing the reference color frequency signature

In step 406, a metric Sj is calculated for each of the Pj different colors in the jth reference color frequency signature. For each of the Pj colors in the jth reference color frequency signature, the fraction Fi of pixels having the ith color is calculated, as is the fraction Gi of pixels having the ith color in the current color frequency signature. Then, for the jth reference color frequency signature, the following calculation is made:

$$Sj = {\sum }_{i = 1}^{Pj} \frac{min ( Fi , Gi )}{max ( Fi , Gi )}$$

The measurement Sj is a rough measure of how well the proportions of the various colors in the jth reference color frequency signature are matched by the proportions of the same colors in a current color frequency signature. The maximum value of Sj is simply the number Pj of colors in the reference color frequency signature, and so if there are four colors in a given color reference frequency signature, Sj can have a maximum value of 4 (i.e., when Fi=Gi for all the i=1, 2, 3, . . . , Pj colors in the jth reference color frequency signature).

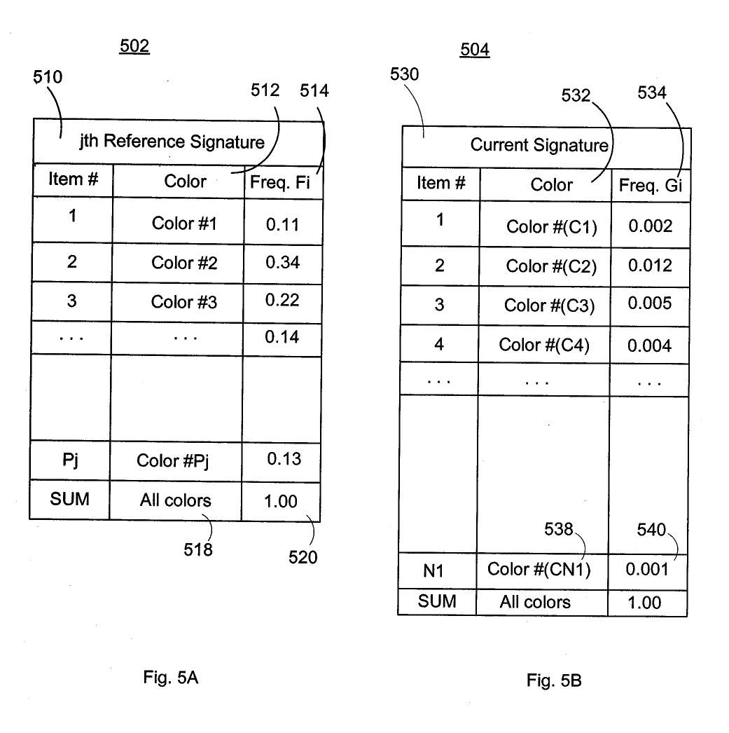

FIG. 5A shows an exemplary reference color frequency signature 510 in the form of a first table 502. Table 502 presents a histogram of the colors 512 for one of the J reference color frequency signatures for a particular camera. This particular reference color frequency signature has a total of Pj colors 512, and each color has a corresponding frequency Fi 514. For instance, color #1 in table 502 has a frequency F1 of 0.11, meaning that 11% of the pixels in this reference color frequency signature are of color #1. As also seen in the table 502, the sum of all such reference color frequencies 518 in the jth reference signature 510 has a total value 520 of 1.0.

FIG. 5B shows an exemplary current color frequency signature 530 in the form of a second table 504. Table 504 presents a histogram of the colors 532 for some current color frequency signature for the same camera. This particular current color frequency signature has a total of N1 colors, and each color has a corresponding frequency Gi 534. Thus, color #(C1) in table 504 has a frequency of 0.002, while color #(CN1) 538 has a frequency of 0.001; the sum of all such current color frequencies 538 has a total value 540 of 1.0.

In general, when performing the test depicted in step 230, some of the colors 532 in the current color frequency signature 530 will be the same as those in the jth reference color frequency signature 510, and it is only these matching colors which contribute a non-zero amount to the value of Sj.

In step 408, the ratio of Mj=Sj/Pj is stored. Since Mj is simply the calculated value Sj normalized by the number Pj of colors in the reference color frequency signature, Mj has a maximum value of 1.0 (and range from 0.0-1.0), and serves as a “color matching density”.

In step 410, a check is made to see whether all of the J reference color frequency signatures for a given camera have been considered. If not, control flows to step 412 where the counter j is incremented and steps 406, 408 and 410 are repeated for the next reference color frequency signature.

If at step 410, it is determined that all of the J reference color frequency signatures for a given camera have been considered, then control goes to step 414 where the maximum M* of all the Mj values is determined. M* is the largest color matching density value and so corresponds to the reference color frequency signature that is closest to the current color frequency signature, which has a corresponding index i*

In step 416, a check is made to see whether M* satisfies a threshold condition. In one embodiment, the threshold condition is whether M*>Tm, where Tm is some predetermined threshold Tm. In other embodiments, instead of exceeding the threshold Tm, the condition might be that M*>Tm (i.e., M* is no less than the threshold Tm). By way of example, the threshold Tm can be set to 0.7, though it may be set at other values instead.

If, at step 416, it is determined that M* satisfies the threshold condition, then control passes to step 418 where the current image is classified as belonging to the j*th reference color frequency signature of the particular camera type. A status ID is set to an appropriate value, based perhaps on a lookup table, database or the like, to indicate the condition of the image. Control then goes to step 240 (discussed below). If, on the other hand, at step 416, it is determined that M* does not satisfy the threshold condition, then control passes to step 232 where the brightness of the current image is evaluated.

In step 232, the brightness of the current image is checked. Brightness may be tested using one of several established methods known to those skilled in the art. For instance, brightness may be determined in HSB color space by taking the average “B” value of all the pixels in the HSB color space. In one embodiment, the image is considered bad if its brightness in the HSB color space is either less than 15% or greater than 85%, of the maximum value. It is understood, however, that brightness may instead be determined in the RGB color space by totaling the arithmetic mean of the red, green and blue 8-bit color values. Regardless of which space is used to determine brightness, one may adjust the brightness thresholds for outdoor cameras based on time of day, sunrise/sunset times and the like. In addition, a priori knowledge about the camera location and acceptable camera operating conditions (e.g., whether it is acceptable for the camera to see brightness below the threshold due to nighttime operation where there are no streetlights) may be take into consideration on a camera-by-camera basis.

If, at step 232, it is determined that the current image brightness is bad (i.e., unacceptable), a status ID is set to an appropriate value to indicate the condition of the image, and control goes to step 240. If, on the other hand, at step 232, it is determined that the current image brightness is not bad (i.e., acceptable), then control goes to step 236 where the hue of the current image is evaluated.

A step 236, hue may be determined by using established industry standards such as converting the image pixels into the HSB space and then creating a hue histogram, which places the various pixels into each of a predetermined number H1 bins. In one embodiment, H1=360 hue bins. The current image may be considered to have bad (i.e., unacceptable) hue if the total numbers of hues is less than some second predetermined number H2, e.g., H2=10 hues total in the image out of H1=360 possible hues. In another embodiment, the current image may be considered to have bad hue if any single hue bin has a pixel count greater than some third predetermined percentage H3, e.g., H3=50% of the total pixel count in the image.

If, at step 236, it is determined that the current image hue is bad (i.e., unacceptable), a status ID is set to an appropriate value to indicate the condition of the image, and control goes to step 240. If, on the other hand, at step 236, it is determined that the current image hue is not bad (i.e., acceptable), then the image status ID is set to indicate that the current image is good (e.g., set to 0), and control then proceeds to step 240.

In step 240, the current image status ID, as determined by the predefined error-image check, the brightness check and the hue check for the current image from camera #ABCD is updated. Next, in step 242, the current image is stored to disk as the current image for camera #ABCD.

In step 244, the current status ID code is compared with the previously stored status ID code for camera #ABCD. If there has been a change in the status ID code of camera #ABCD from the previous time the camera was evaluated, control flows to step 246 and the current image is also stored as the “historical” image for camera #ABCD, the historical image corresponding to the image whose analysis resulted in the current status ID code. Next, in step 250, ‘first occurrence of present state’ and the ‘last occurrence of present state’ fields are updated with the current time, and the ‘duration of present state’ field is set to 0:00 (since, initially at least, first occurrence=last occurrence).

If, at step 244, it is determined that there has been no change in the status code of camera #ABCD, the “historical” image remains unchanged and, at step 248, the ‘last occurrence of present state’ field is updated with current time and the ‘duration of present state’ field is updated accordingly.

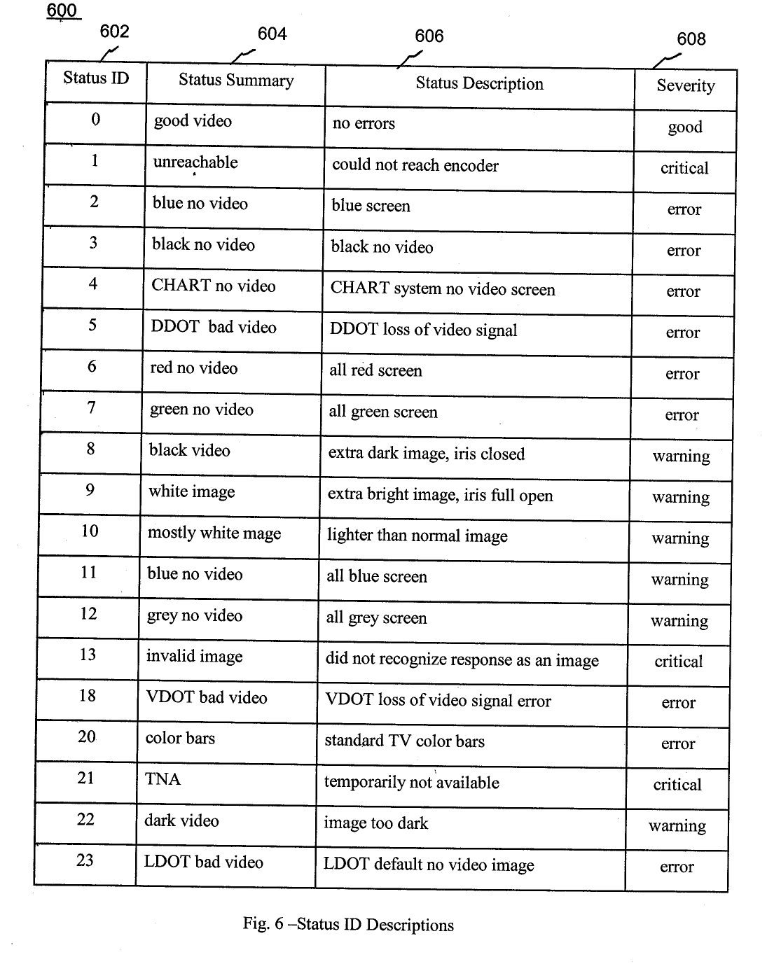

FIG. 6 presents a look-up table 600 showing exemplary status ID's 602, the corresponding status summaries 604, the corresponding detailed status descriptions 606, and the corresponding status severity, for a plurality of cameras operated by different entities.

Table 1, below, maps the severity level to a description of its seriousness. This seriousness information may be used by a person charged with monitoring the cameras in prioritizing which cameras should receive attention first.

TABLE 1
Severity Descriptions

| Severity Level | Severity Description |
|---|---|
| 1 | Critical |
| 2 | Error |
| 3 | Warning |
| 4 | Green (good video) |

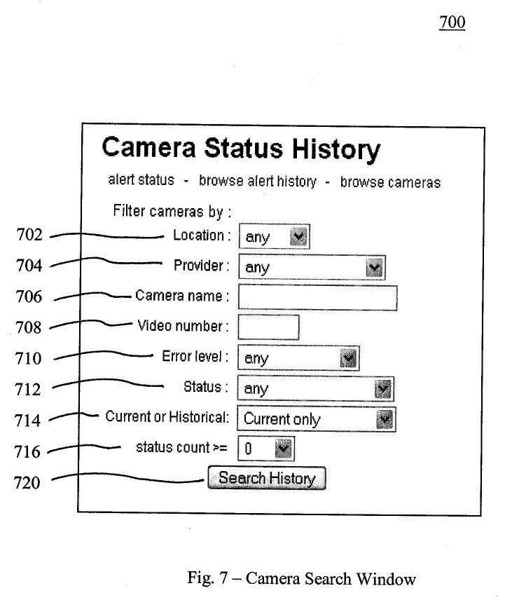

FIG. 7 presents a web page presenting a “Camera Status History Search” window 700 from which a user may access information about the quality of imagery from the cameras connected to a network. It is understood that different users may have different privileges. For instance, a user working for a particular department of transportation may only have access to information about cameras under their control. In contrast, the web site operator may have access to all the cameras. Such privileges may be implemented in any one or more known ways, such as through a login process and a look-up table that keeps track of the cameras about which a given user may obtain quality information.

FIG. 7 shows a “Camera Status History Search” window 700, which allows a user to specify the cameras whose quality performance is to be viewed. For this, the search window 700 allows a user to select a combination of parameters. Among these parameters is the camera location 702, the camera operator 704, the camera name 706, the camera number 708, the status severity 710 (e.g., good, critical, warning, error), the status summary 712, whether only the most current status or additional history is desired 714, and the maximum number of statuses 716 to be returned. As seen in FIG. 7, a number these parameters may be selected from pull-down menus, to assist in the specification process. Once the user has specified the various parameters, the user activates a search button 720 to initiate the search.

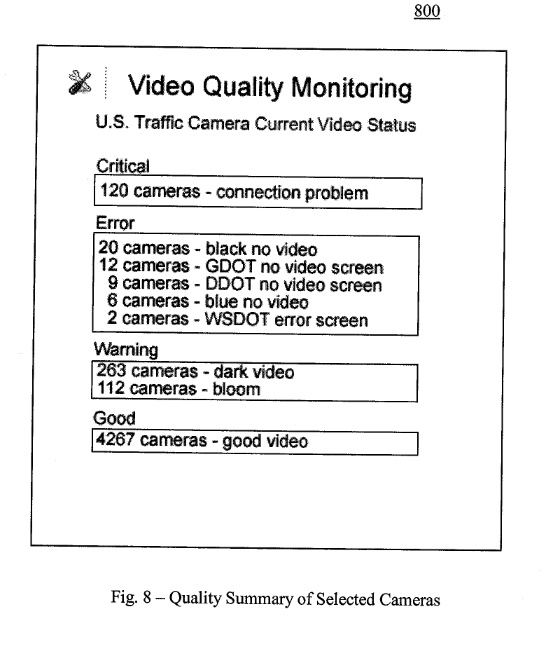

FIG. 8 shows a video quality monitoring window 800, which indicates the number of cameras having each type of status summary, and grouping them together by severity level. Thus, window 800 provides the user with consolidated information about the status of the selected cameras.

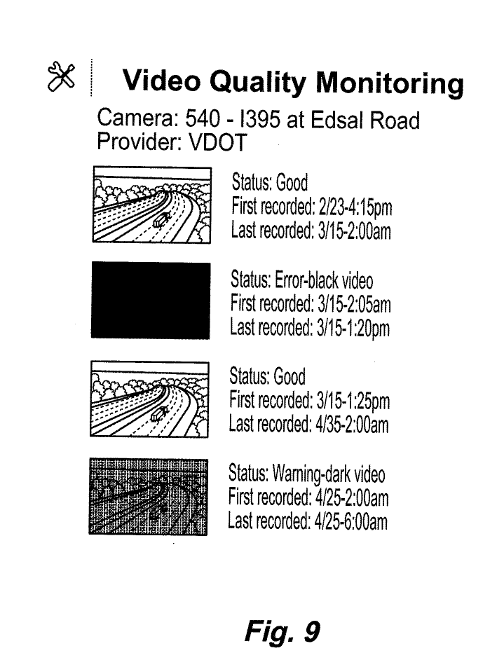

FIG. 9 shows a video quality history window 900. The system logs changes in the status of each camera, and stores an exemplary snapshot of each status, and the start and end time of each such status. Window 900 presents this information in a manner that allows a user to see this history. Thus, for each status experienced by a particular camera 910 over a predetermined time period, window 900 presents an exemplary snapshot 912, the severity 608 and status summary 606, and the start time 920 and end time 922 defining the duration of that particular status.

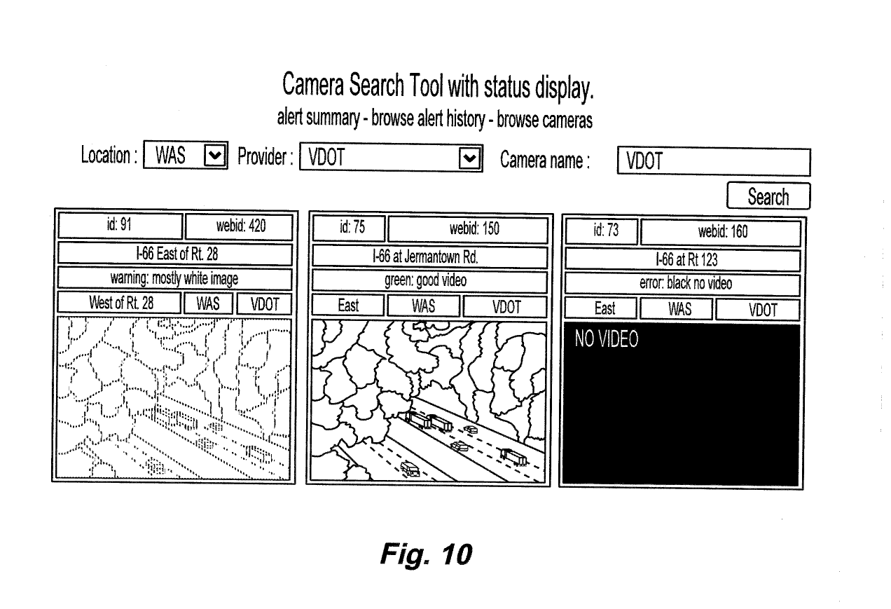

FIG. 10 displays exemplary real-time video feeds for a plurality of selected cameras. In this instance cameras having a common camera name 1002 (or camera name portion) from a common provider 1004 are selected. For each camera, the camera ID 1012 and the full camera name 1014 are displayed, as are the status summary 606 and the status severity 608, in addition to the video 1020A, 1020B, 1020C.

Although the present invention has been described to a certain degree of particularity, it should be understood that various alterations and modifications could be made without departing from the scope of the invention as hereinafter claimed.

What is claimed is:

1. A method for automatically determining whether each of a plurality of video cameras placed in different geographical locations and operated by different entities, is operating properly based on imagery provided by each such video camera, the plurality of video cameras including video cameras of different types, the method comprising:
for each of said plurality of video cameras:
(a) obtaining a current image from a selected video camera over an internet protocol network, each current image comprising a two-dimensional array of pixels having an integer number N bits;
(b) histogramming pixels of the current image to form a current image signature using only a reduced integer number M bits to represent pixel values within the current image, M<N; and
(c) comparing the current image signature with at least one reference color frequency signature appropriate for a camera type of said selected video camera, to determine whether said selected video camera is outputting a pre-defined error image.

2. The method according to claim 1, further comprising:
if it is determined that a particular video camera is outputting an error image:
updating a database to reflect a status of said particular video camera; and
notifying an operator of said particular video camera that said particular video camera is not operating properly.

3. The method according to claim 1, comprising:
establishing a first database comprising pre-defined error image signatures for said plurality of video cameras, prior to comparing the current image signature with at least one pre-defined error image signature.

4. The method according to claim 3, comprising:
adding, to said first database, at least one new pre-defined error image signature for a new video camera added to said plurality of video cameras by an entity operating said new video camera.

5. The method according to claim 1, comprising:
comparing current information about the current image said selected video camera with stored information about an earlier image from said selected video camera, to determine whether an operating condition of said selected video camera has changed in the interim.

6. The method according to claim 1, further comprising:
if it is determined that a particular video camera is not outputting an error image:
determining whether the current image is too bright or too dark.

7. The method according to claim 6, wherein:
an image is consider too bright if an average brightness of the pixels is above 85%; and
an image is consider too dark, if an average brightness of the pixels is below 15%.

8. The method according to claim 6, comprising:
adjusting at least one brightness threshold value for said selected camera, based on one or more factors specific to a location said selected camera.

9. The method according to claim 6, further comprising:
if it is determined that a current image is not too bright or too dark:
creating a hue histogram of the current image, the hue histogram having an integer number K bins; and
determining that the current image is a good image if:
there are at least and L hues in the current image; and
no one hue has more than J % of a total pixel count of the current image.

10. The method according to claim 9, wherein:
there are a total of K=360 hue bins;
there are at least and L=5 hues in the current image; and
no one hue has more than J=60% of a total pixel count of the current image.

11. The method according to claim 1, further comprising:
creating a hue histogram of the current image, the hue histogram having an integer number K bins; and
determining that the current image is a good image if:
there are at least an integer number L hues in the current image; and
no one hue has more than J % of a total pixel count of the current image.

12. The method according to claim 11, wherein:
there are a total of K=360 hue bins;
there are at least L=5 hues in the current image; and
no one hue has more than J=50% of a total pixel count of the current image.

13. The method according to claim 1, further comprising:
displaying information about a current operating status of at least one camera, along with a live video feed from said at least one camera.

14. The method according to claim 1, further comprising:
displaying historical information about past operating status of at least one camera, along with snapshots taken from each such past operating status.

15. A system configured to automatically determine whether each of a plurality of video cameras placed in different geographical locations and operated by different entities, is operating properly based on imagery provided by each such video camera, the plurality of video cameras including video cameras of different types, the system comprising:
(a) means for obtaining a current image from a selected video camera over an internet protocol network, each current image comprising a two-dimensional array of pixels having an integer number N bits;
(b) means for histogramming pixels of the current image to form a current image signature using only a reduced integer number M bits to represent pixel values within the current image, M<N; and
(c) means for comparing the current image signature with at least one reference color frequency signature appropriate for a camera type of said selected video camera, to determine whether said selected video camera is outputting a pre-defined error image.
